(19) United States
(12) Patent Application Publication
(10) Pub. No.: US 2004/0042152 A1
(43) Pub. Date: Mar. 4, 2004

(54) Processing apparatus having a support member made of metal matrix composite between a process chamber and a title placement stage

(75) Inventors: Tadahiro Ishizaka, Nirasaki-shi (JP); Yasuhiko Kojima, Nirasaki-shi (JP); Yasuhiro Oshima, Nirasaki-shi (JP); Takashi Shigeoka, Nirasaki-shi (JP)

Correspondence Address: CROWELL & MORING LLP, INTELLECTUAL PROPERTY GROUP, P.O. BOX 14300, WASHINGTON, DC, 20044-4300, US

(73) Assignee: Tokyo Electron Limited, Minato-ku (JP)

(21) Appl. No.: 10/648,426

(22) Filed: Aug. 27, 2003

(30) Foreign Application Priority Data
Aug. 30, 2002 (JP) 2002-253673

(51) Int. Cl. H02H 1/00

(52) U.S. Cl. 361/234

(57) ABSTRACT

A processing apparatus has a reduced volume of a process chamber by simplifying a support structure of a substrate placement stage so as to perform a high-speed gas exchange. The process chamber made of metal applies a process to an object to be processes placed in the process chamber by supplying a process gas to the object to be processed. A placement stage made of ceramics or a metal matrix composite is located inside the process chamber so that the object to be processed is placed thereon. A heating device is incorporated into the placement stage. A support member made of a metal matrix composite supports the placement stage. A seal member is located between the support member and a wall surface of the process chamber. A cooling mechanism is located in the vicinity of the seal member so as to cool the seal member.

### BACKGROUND OF THE INVENTION

1. Field of the Invention

The present invention generally relates to processing apparatuses and, more particularly, to a processing apparatus for processing an object to be processed such as a semiconductor wafer while heating the object.

2. Description of the Related Art

When forming a thin film using a chemical vapor deposition (CVD) method, generally, a chemical reaction is promoted by heating a substrate to be processed (hereinafter referred to as a processing substrate) having a surface on which the thin film is to be formed. Japanese Laid-Open Patent Application No. 5-335239 and Japanese Patent Publication No. 6-28258 disclose methods for heating a processing substrate for such a purpose. Japanese Laid-Open Patent Application No. 5-335239 discloses a technique to heat a processing substrate by irradiating a light (heat ray) from a halogen lamp to the processing substrate. Additionally, Japanese Patent Publication No. 6-28258 discloses a technique to heat a processing substrate by transferring heat from a resistance-heating element to the processing substrate.

On the other hand, although it is a technology different from the CVD method, an ALD (Atomic Layer Deposition) method has attracted attention in recent years as a method of supplying a process gas to a heated substrate under a reduced pressure so as to form a high-quality thin film on the substrate. The thin film formed by ALD has a low-impurity concentration, and has a good in-plane uniformity. Moreover, as is referred to as high step coverage, it is also the feature of ALD that a thin film which follows a surface configuration (a step) of a substrate. Furthermore, according to ALD, a thin film can be formed at a lower temperature than the conventional CVD, and an accurate control of a film thickness can be achieved.

According to ALD, a plurality of kinds of source gases are supplied to a substrate so as to react with each other on the substrate to form a thin film of a reaction product. In this regard, the plurality of kinds of source gases must be supplied one after another by switching so that the source gases do not react with each other before reaching the substrate. That is, after only one kind of source gas is supplied to the substrate, the supplied gas is exhausted completely and, then, a different kind of source gas is supplied. Such a process is repeated so as to grow a thin film to have a certain thickness.

In the above-mentioned processing method in which source gases are sequentially supplied by switching, it is indispensable to switch the source gases at high speed to improve a throughput. In the switching of the source gases, after exhausting one kind of supplied source gas is completely exhausted from a reaction chamber, and, thereafter, a next kind of source gas is supplied to the reaction chamber. Therefore, in order to exhaust a source gas from the reaction chamber, it is effective, when the supply of the source gas is stopped, to lessen an amount of the source gas remaining in the reaction chamber. That is, it is effective for improvement in the processing speed to reduce the volume of the reaction chamber in in which one end of a hollow convex support member is connected to the substrate placement stage, the other end is connected to a wall of the reaction chamber, and the electrodes are extended out of the reaction chamber by being passed through a hollow part of the convex support member. In such a structure, in order to maintain the airtightness of a junction part between the convex support member and the reaction chamber, a seal member such as an O-ring is used. Since an O-ring is formed of a polymeric material, such as a resin or a rubber, it is necessary to maintain a temperature of the junction part below a heat-resistant temperature of the O-ring.

Here, the processing temperature of the processing substrate is normally 400° C.-500° C., while the heat-resistant temperature of the above-mentioned seal member is about 150° C. Therefore, a part of the convex support member on a side of the placement stage reaches a high temperature of 400° C.-500° C., while a part of the convex support member on a side of the junction part must be decreased to a temperature of about 150° C.

For this reason, the temperature of the portion where the O-ring is provided is forcibly cooled by arranging a cooling pipe near that portion to allow a cooling water passed therethrough. Additionally, a structure is used where a distance between the junction part and the substrate placement stage into which the resistance-heating element is incorporated is increased so as to lower the temperature of the junction part due to its temperature gradient. Namely, the length of the convex support member is increased to lower the temperature of the junction part.

However, if the length of the convex support member is large, the volume of the reaction chamber becomes inevitably large, which results in an increase in the volume of the portion in which a source gas remains as mentioned above. Thereby, it becomes impossible to perform a high-speed exhaust of a source gas.

The length of the convex support member can be reduced by forming the convex support member by ceramics such as aluminum nitride (AlN) having a low thermal conductivity. However, in such a case, a temperature difference between one and the other end of the convex support member is large, which may raise a problem in that a crack occurs in the ceramics made convex support member due to a thermal stress.

Here, if the substrate placement stage is directly joined to a wall of the reaction chamber without providing the convex support member therebetween, the volume of the reaction chamber can be reduced. However, in such a case, it is necessary to join the ceramic made placement stage to the metal made reaction chamber. When brazing is used for the junction, since there is a large difference in coefficients of thermal expansion between ceramics and metal (the coefficient of thermal expansion of aluminum nitride (AlN) is 4.5×10⁻⁶/° C. while the coefficient of thermal expansion of aluminum (Al) is 22×10⁻⁶/° C.), it is possible that the ceramics made placement stage cracks due to a thermal stress generated by heat of brazing.

### SUMMARY OF THE INVENTION

It is a general object of the present invention to provide an improved and useful processing apparatus in which the above-mentioned problems are eliminated.

A more specific object of the present invention is to provide a processing apparatus which has a reduced volume of a process chamber by simplifying a support structure of a substrate placement stage so as to perform a high-speed gas exchange.

In order to achieve the above-mentioned objects, there is provided according to the present invention a processing apparatus comprising: a process chamber made of metal for applying a process to an object to be processes placed in the process chamber by supplying a process gas to the object to be processed; a placement stage made of ceramics or a metal matrix composite located inside the process chamber so that the object to be processed is placed thereon; a heating device incorporated into the placement stage; a support member made of a metal matrix composite for supporting the placement stage; a seal member located between the support member and a wall surface of the process chamber; and a cooling mechanism located in the vicinity of the seal member so as to cool the seal member.

In the processing apparatus according to the present invention, the support member may be joined to a surface of the placement stage opposite to a surface on which the object to be processed in placed. The support member may have a substantially flat shape, and an entire surface of the placement stage opposite to a surface on which the object to be processed in placed may be joined to a flat surface of the support member. The support member may be formed as a part of a wall of the process chamber. The support member may be formed as a bottom plate of the process chamber.

Additionally, the cooling mechanism may include a coolant passage formed in the support member. The cooling mechanism may include a coolant passage formed in a wall of the process chamber. The support member may be joined to the placement stage by blazing.

According to the above-mentioned invention, the support member formed of the metal matrix composite having a coefficient of thermal expansion substantially equal to a coefficient of thermal expansion of the placement stage is located between the placement stage formed of ceramics or a metal matrix composite and the process chamber made of metal. Thereby, the placement stage and the support member can be easily joined to each other by a blazing material such as a silver-blazing material or an aluminum-blazing material, and the placement stage can be arranged in the process chamber by attaching the support member to the process chamber. Since the joint by blazing provide airtightness, there is no need to arrange a seal member in the joint part.

Additionally, by forming the support member formed of the metal matrix composite as a part of a wall of the process chamber, the placement stage can have a structure in which the placement stage is directly joined to the wall of the process chamber, thereby forming the process chamber having a small volume. Further, the electrode of the heating device incorporated into the placement stage can be extended out of the process chamber through a through hole of the support member. Since the seal of the through hole is achieved by the joint by the above-mentioned blazing, there is no need to provide a special seal member. Thus, if a normal seal member such as an O-ring is located between the support member and the process chamber wall, the airtightness of the process chamber can be achieved with a simple structure.

Other objects, features and advantages of the present invention will become more apparent form the following detailed description when read in conjunction with the accompanying drawings.

### BRIEF DESCRIPTION OF THE DRAWINGS

FIG. 1 is a cross-sectional view of a processing apparatus according to a first embodiment of the present invention;

FIG. 2 is a cross-sectional view of the processing apparatus having lifter-pins and a moving mechanism;

FIG. 3 is a cross-sectional view of the processing apparatus having lifter-pins and a moving mechanism; and

FIG. 4 is a cross-sectional view of a processing apparatus according to a second embodiment of the present invention.

### DETAILED DESCRIPTION OF THE PREFERRED EMBODIMENTS

A description will now be given, with reference to the drawings, of embodiments of the present invention.

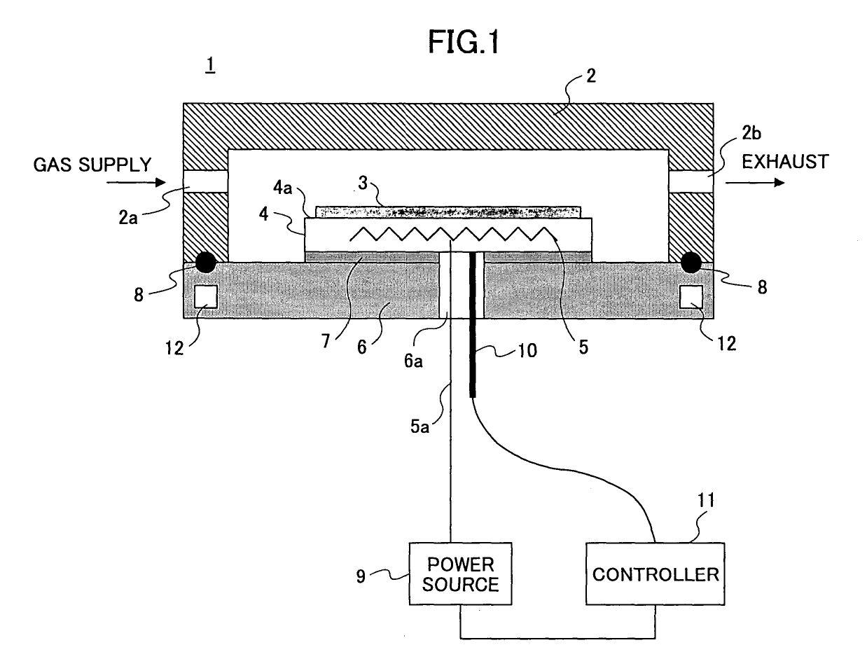

FIG. 1 is a cross-sectional view of a processing apparatus according to a first embodiment of the present invention. The processing apparatus 1 according to the first embodiment of the present invention is an apparatus which forms a thin film on a surface of a substrate to be processed (processing substrate) by supplying a plurality of kinds of source gases alternatively one after another onto the processing substrate under a reduced pressure. When supplying the source gases to the processing substrate, the processing substrate is heated so as to promote the reaction of the source gases.

The processing apparatus 1 has a process chamber 2, and a susceptor 4 is arranged in the process chamber 2 as a placement stage on which a wafer 3 as a processing substrate is placed. A process chamber 2 is formed of stainless steel, aluminum, etc., and a processing space is formed inside the process chamber 2. When the process chamber 2 is formed of aluminum, surface treatment such as an anodic oxide coating process may be applied to the surface of the process chamber 2. The sidewalls of the process chamber 2 are provided with a gas supply port 2a for supplying a process gas and an exhaust port 2b for exhausting the process gas.

The susceptor 4 incorporated therein an electric heater 5 such as a tungsten wire so as to heat the wafer 3 placed on a placement surface 4a of the susceptor 4 by heat generated by the heater 5. The susceptor 4 is formed of a ceramic material such as aluminum nitride (AlN) and alumina (Al₂O₃). Moreover, the susceptor 4 can also be formed by a metal-ceramic composite material mentioned below.

The susceptor 4 is joined to a suport member 6 by a blazing material 7 such as a silver blazing material or an aluminum blazing material. The support member 6 is formed as a generally flat plate member, and is connected to the process chamber 2 via a sealing member such as an O-ring. In the present embodiment, the support member 6 substantially functions as a process chamber wall (a bottom plate of the process chamber).

Here, when the support member 6 if formed of a metal such as stainless-steel or aluminum and if the susceptor 4 is joined to the support member 6 by a blazing material, it is possible that the susceptor cracks due to a thermal stress during the blazing. Thus, in the present embodiment, the support member 6 is formed of a metal-ceramic composite material or metal matrix composite (MMC) so as to permit the blazing joint of the susceptor 4 and the support member 6. That is, the metal matrix composite has a low thermal expansion coefficient close to ceramics such as AlN or alumina, and is capable of being blazed. Thus, metal matrix composite can be easily joined to ceramics by blazing without cracking as mentioned above.

In the present embodiment, the following kinds of metal matrix composite can be used as the material of the support member 6.

a) when the susceptor is formed by AlN:

metal . . . aluminum (Al)

ceramics . . . SiC, SiN, Al₂O₃

other ingredients . . . Si

Volume percentage of the ceramics is 10-85%.

b) when the susceptor is formed of Al₂O₃:

metal . . . aluminum (Al)

ceramics . . . SiC, SiN, AlN

other ingredients . . . Si

Volume percentage of the ceramics is 10-85%.

c) when the susceptor is formed of SiC:

metal . . . aluminum (Al)

ceramics . . . SiC, SiN, Al₂O₃

other ingredients . . . Si

Volume percentage of the ceramics is 10-85%.

The above-mentioned metal matrix composites are materials having an aluminum alloy as a matrix material and ceramics is compounded as a reinforcing material. Thus, the metal matrix composites are light and have a high rigidity similar to aluminum, and have a sufficient strength as a process chamber wall. Additionally, the metal matrix composites have a low thermal expansion coefficient close to that of ceramics, and is capable of being joined to ceramics by blazing.

Further, the above-mentioned metal matrix composites have a strength against a temperature gradient as compared to ceramics. Therefore, when the susceptor 4 is at a high temperature of 400° C. to 500° C. and if a part where a seal member 8 is provided is cooled to about 150° C., the support member 6 does not crack due to a temperature gradient.

In FIG. 1, an opening 6a is provided in support member 6 formed as the bottom plate of the process chamber 2, and electrodes or electric power supply line 5a of the electric heater 5 is extended to outside of the process chamber 2 through the opening 6a. The electric power supply line 5a is connected to a power source 9, and electric power is supplied to the electric heater 5 from the power source 9 through the electric power source line 5a. A thermocouple 10 for detecting a temperature of the susceptor 4 is also attached to the susceptor through the opening 6a. The thermocouple 10 is connected to a controller 11, and the controller 11 controls the electric power supplied to the electric heater 5 from the power source 9 based on the temperature of the susceptor 4 detected by the thermocouple 10.

It should be noted that since the opening 6a communicates with an exterior of the process chamber 2, it is necessary to seal the opening 6a. Such a seal can be achieved simultaneously when joining the support member to the susceptor 4 by blazing as mentioned above. Therefore, any special seal member is not needed to seal the opening 6a.

The part where the support member 6 is connected to the process chamber 2 is sealed by the seal member 8 such as an O-ring as mentioned above. A coolant passage 12 as a cooing mechanism is provided in the vicinity of the part where the seal member is provided so as to cool the part where the seal member 8 is provided. In the present embodiment, the part where the seal member 8 is provided is cooled to a temperature of about 150° C. by using a cooling water as a coolant. Therefore, is the susceptor 4 is heated to a high temperature of 400° C. to 500° C., a material such as Viton (Registered Trademark), Kalrez (Registered Trademark) or polyimide resin can be used as the seal member 8.

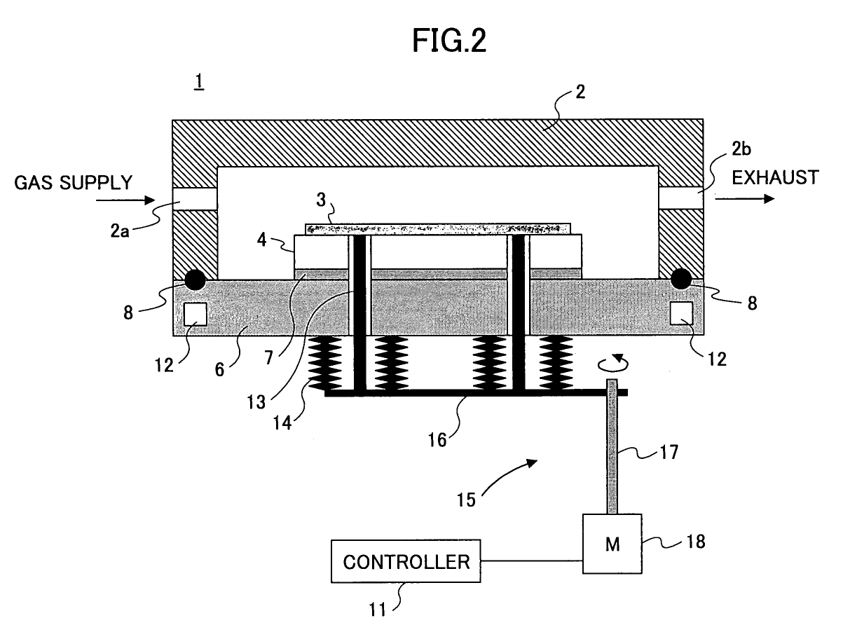

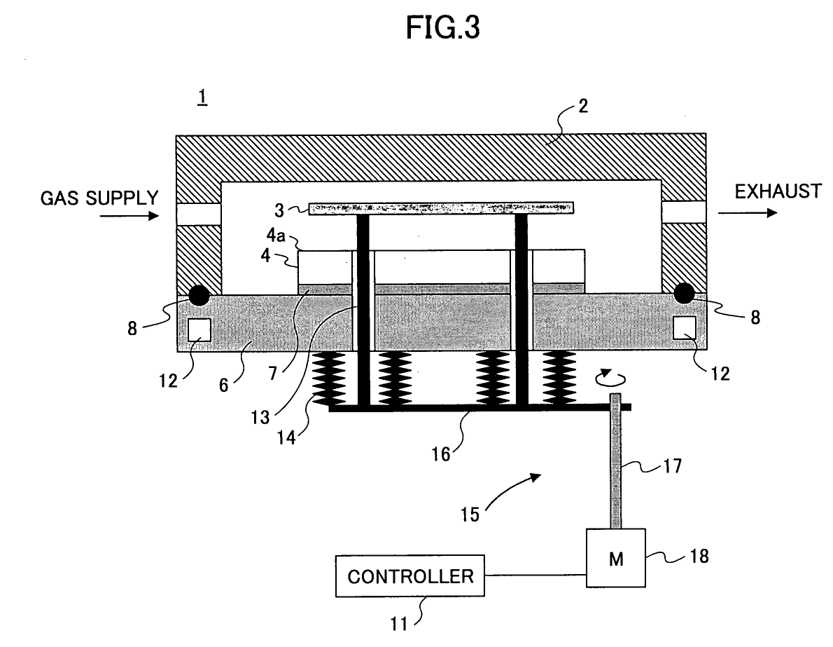

In the processing apparatus 1 shown in FIG. 1 is provided with push-up members and a moving mechanism thereof for lifting the wafer 3 as a processing substrate placed on the susceptor 4. FIGS. 2 and 3 are cross-sectional views of the processing apparatus 1 which has lifter-pins and a moving mechanism thereof. In FIGS. 2 and 3, parts that are the same as the parts shown in FIG. 1 are given the same reference numerals, and descriptions thereof will be omitted. It should be noted that, in FIGS. 2 and 3, the opening 6a and the electric heater 5 shown in FIG. 1 are not illustrated.

It is necessary to lift the wafer 3 placed on the susceptor 4 in the process chamber 1 above a placement surface 4a of the susceptor 4 when the wafer 3 is conveyed. For this reason, the susceptor 4 is provided with a plurality of lifter-pins 13 (push-up members) that extend through the susceptor 4 and are movable in a vertical direction. The lifter-pins 13 extend through the support member 6 as the bottom plate of the process chamber 2, and also extend through the susceptor 4. In order to maintain the airtightness of the process chamber 2, a metal bellows 14 made of a stainless steel or the like is provided on a side of an end part of each lifter-pin 13 which extends outside the support member 6.

The lifter-pins 13 are movable in the vertical direction by a lifter-pin moving mechanism 15. The lifter-pin moving mechanism 15 comprises: a lifter-pin support member 16 connected to the end parts of the lifter-pins 13; a ball-screw 17 engaged with an end of the lifter-pin support member 16; and a motor 18 rotationally drive the ball-screw 17. The ball-screw 17 rotates by the motor being driven, thereby moving the lifter-pin support member 16 in the vertical direction. Therefore, the lifter-pins 13 connected to the lifter-pin support member 16 move in the vertical direction. An operation of the motor 18 is controlled by the controller 11.

FIG. 2 shows a state where the wafer is being processed, and the lifter-pins 13 are moved down so that the wafer 3 is placed on the susceptor 4. FIG. 3 shows a state where wafer 3 is conveyed, and the lifter-pins 13 are moved up so that the wafer 3 is lifted above the placement surface 4a of the susceptor 4. As mentioned above, by lifting the wafer 3, the wafer 3 can be grasped and conveyed by a conveyance arm (not shown in the figure) inserted from an exterior of the process chamber 2.

It should be noted that, the lifter-pin moving mechanism is not limited to the above-mentioned structure, and a conventional moving mechanism may be used if necessary.

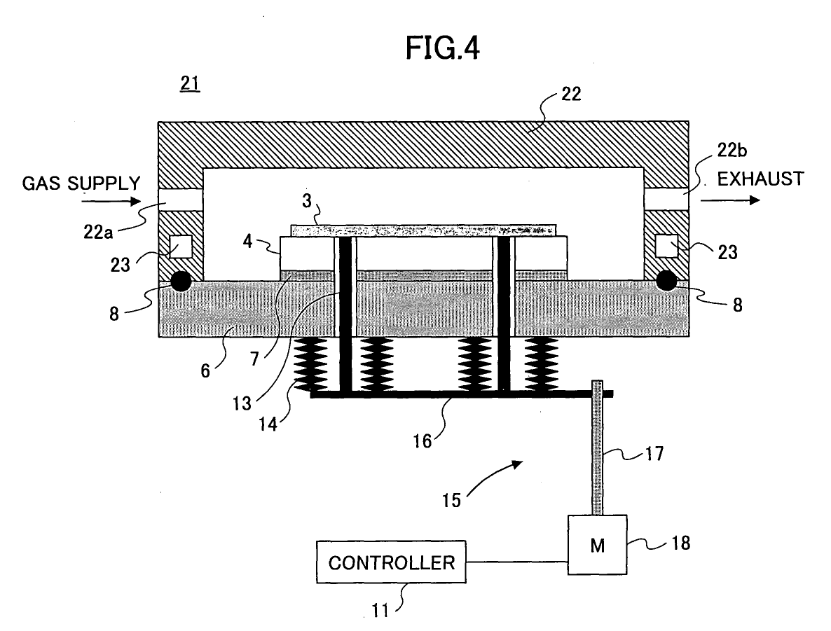

A description will now be given, with reference to FIG. 4, of a processing apparatus according to a second embodiment of the present invention. FIG. 4 is a cross-sectional view of the processing apparatus 21 according to the second embodiment of the present invention.

In FIG. 4, parts that are the same as the parts shown in FIGS. 1 through 3 are given the same reference numerals, and descriptions thereof will be omitted.

Although the processing apparatus 21 shown in FIG. 4 has fundamentally the same structure as the processing apparatus 1 shown in FIG. 1, the location of the coolant passage is different. Although the coolant passage 12 is provided in the support member 6 in the vicinity of the seal member 8 in the processing apparatus 1 shown in FIG. 1, a coolant passage 23 of the processing apparatus 21 shown in FIG. 4 is provided in the wall of a process chamber 22 in the vicinity of the seal member 8. It should be noted that, also in the present embodiment, the process gas is supplied from a gas supply port 22a provided in the sidewall of the process chamber 22, and is exhausted outside the process chamber 22 through an exhaust port 22b.

According to the arrangement of the coolant passage 23 of the present embodiment, when cooling the seal member 8 to the same temperature, a temperature gradient of the support member 6 can be gentler than that of the structure shown in FIG. 1. Namely, since the temperature of the coolant passage 23 is lower than the temperature of the seal member 8, the temperature gradient in the support member in the structure shown in FIG. 4, in which a distance between the cooling passage 23 and the susceptor 4 is larger, is gentler. Thereby, the prevention of crack of the support member 6 due to a thermal stress can be further assured.

It should be noted that although the susceptor 4 and the support member 6 are joined to each other by a blazing material such as a silver-blazing material or an aluminum-brazing material in the above-mentioned embodiments, they can be joined to each other by interposing a powder of titanium (Ti) or titanium hydride between the susceptor 4 and the support member 6, instead of using a blazing material, and heating at a temperature of 700° C. to 900° C. in a nitrogen (N₂) atmosphere.

The present invention is not limited to the specifically disclosed embodiments, and variations and modifications may be made without departing from the scope of the present invention.

The present invention is based on Japanese priority application No. 2002-253673 filed Aug. 30, 2003, entire contents of which are hereby incorporated by reference.

What is claimed is:

1. A processing apparatus comprising:
a process chamber made of metal for applying a process to an object to be processes placed in the process chamber by supplying a process gas to the object to be processed;
a placement stage made of ceramics or a metal matrix composite located inside the process chamber so that the object to be processed is placed thereon;
a heating device incorporated into the placement stage;
a support member made of a metal matrix composite for supporting said placement stage;
a seal member located between said support member and a wall surface of said process chamber; and
a cooling mechanism located in the vicinity of said seal member so as to cool said seal member.

2. The processing apparatus as claimed in claim 1, wherein said support member is joined to a surface of said placement stage opposite to a surface on which the object to be processed in placed.

3. The processing apparatus as claimed in claim 1, wherein said support member has a substantially flat shape, and an entire surface of said placement stage opposite to a surface on which the object to be processed in placed is joined to a flat surface of said support member.

4. The processing apparatus as claimed in claim 1, wherein said support member is formed as a part of a wall of said process chamber.

5. The processing apparatus as claimed in claim 4, wherein said support member is formed as a bottom plate of said process chamber.

6. The processing apparatus as claimed in claim 1, wherein said cooling mechanism includes a coolant passage formed in said support member.

7. The processing apparatus as claimed in claim 1, wherein said cooling mechanism includes a coolant passage formed in a wall of said process chamber.

8. The processing apparatus as claimed in claim 1, wherein said support member is joined to said placement stage by blazing.
